(19) United States
(12) Patent Application Publication
(10) Pub. No.: US 2017/0023236 A1
(43) Pub. Date: Jan. 26, 2017

(54) Vortex Tube Supplying Superheated Vapor for Turbine Power Generation

(71) Applicant: William David Hardgrave, Carrollton, TX (US)

(72) Inventor: William David Hardgrave, Carrollton, TX (US)

(21) Appl. No.: 15/289,382

(22) Filed: Oct. 10, 2016

Related U.S. Application Data
(63) Continuation of application No. 14/827,329, filed on Aug. 16, 2015.
(60) Provisional application No. 62/038,788, filed on Aug. 18, 2014.

(51) Int. Cl. F22B 3/00; F01K 7/16; F01K 25/08; F01K 11/02; F01D 9/02

(52) U.S. Cl. CPC F22B 3/00; F01K 11/02; F01D 9/02; F01K 25/08; F01K 7/16; F05D 2240/127; F05D 2220/31

(57) ABSTRACT

The vortex tube when properly used within a Rankine cycle can produce phenomenal results. This invention functionally describes the preferred vortex tube used to produce superheated vapor from a compressed heated liquid without summoning the additional heat required for latent-heat to effect vaporization. The vortex tube provides superheated vapor to a turbine for generating electricity burning 50% less fossil fuel, also releasing 50% less carbon emissions to the environment. The vortex tube extends the efficient Rankine Cycle temperature range well below 150° F. with the proper refrigerant choice. The physical size and function of the hearing equipment is reduced. The invention delivers new thermal efficiencies for both the Rankine Cycle and the Organic Rankine Cycle.

### RELATED APPLICATION DATA

This application this application is a Continuation Application of Utility patent application Ser. No. 14/827,329 filed on Aug. 16, 2015, and priority is claimed for this earlier filing under 35 U.S.C. §120, which is related to Provisional Patent Application Ser. No. 62/038,788 filed on Aug. 18, 2014, and priority is claimed for this earlier filing under 35 U.S.C. §119(e). This Provisional Patent Application and prior Utility Patent Application are incorporated by reference into this Continuation Patent Application.

### BACKGROUND

The United States relies on coal, natural gas, oil, hydroelectric and nuclear power for about 95% of its electricity. The world derives about 97% of its energy from the fossil fuels—coal, natural gas and oil. A reliable prediction estimates that about 80% of the world's energy will still come from fossil fuels in 2045. Burning fossil fuels produces carbon emissions, which escape to the atmosphere and trap the sun's heat, therefore, warming the atmosphere. Barring irreversible regulations, the world's energy will continue to come from fossil fuels for the foreseeable future. Therefore, the burning of fossil fuels is where the major breakthrough innovations need to happen that will truly disrupt and recreate the power industry.

The theory goes, that as the world's governments attempt to slow global warming by moving away from using fossil fuels by the end of this century, urgent and concrete action is needed to address climate change. The leaders of seven wealthy democracies (G7) have agreed to decarbonize the global economy—that is, to eliminate most carbon dioxide emissions from burning oil, gas or coal. Government regulations will drive this effort to force a reduction in burning fossil fuels that produce carbon dioxide.

The G7 leaders agreed to press for a reduction in carbon dioxide emissions by 2050 of 40% to 70% of the base year 2010 global emission levels for greenhouse gases and promised to transform the energy sectors in their respective countries to produce fewer carbon emissions. The EPA Final Rules require the nation's power plants to cut emissions 32% from the base year 2005 global emission levels by 2030.

Most societies will not follow a low-energy, low-development path, regardless of whether they work or not to protect the environment. If the world's 9 billion human beings are offered a chance at genuine fossil fuel driven development resulting in a better life style, fossil fuels will be burned without regard for the environment or fellow mankind.

Decarbonization is open to interpretations that include the use of some fossil fuels. If the amount of fossil fuel burned in 2010 to generate a unit of electrical power is reduced to produce the same unit of electrical power today, this would demonstrate decarbonization. The major breakthrough innovations must start with the process of burning of fossil fuels and improving the basic Rankine Cycle to change the way fossil fuels are converted to electrical power. This invention investigates and offers an improvement in the basic Rankine Cycle process. This invention can substantially reduce the carbon emissions of a central power plant by more than 50% for the next decades.

The Rankine Cycle can be altered to increase its efficiency and functionality. Efficiency increases are achieved by extending the lower temperature heat source range and reducing the amount of heat required to produce a dry vapor. These changes result in reducing the amount of pollutants released to the atmosphere—an environmental benefit. One alteration to investigate is adding a vortex tube to the Rankine Cycle. This change would allow a lower initial temperature cycle input to be reset to a higher temperature state than the lower source temperature input, and provide this higher temperature state stream into the turbine inlet. With a higher-temperature state stream input that draws on the Rankine Cycle's innate ability to be more efficient at higher temperatures, the turbine is then enabled to produce electrical power more efficiently. It can produce dry vapor directly from a heated compressed liquid, not passing through the common phase change. The phase change, commonly called “flashing,” is defined as changing a liquid to a dry vapor. Note the liquid does not start to change phase until its bubble point has been reached. “Flashing” a liquid is defined as a process that causes a phase change when heat is added to a liquid, starting from the liquid bubble point and continuing until a completely dry vapor is created. The amount of heat to effect this phase change, at constant temperature and pressure, is called “Latent Heat.” The present invention provides a process to directly produce a dry vapor that obviates heat to effect the phase change. In essence, “Latent Heat” is not needed to generate dry vapor.

Using the vortex tube coupled with other design changes will alter the Rankine Cycle to increase its functionality. The conventional Rankine Cycle demands a robust heat exchanger designed to handle liquids and supercritical vapors. The altered Rankine Cycle requires a simpler construction; i.e. water/refrigerant heater that handles only hot liquid refrigerant/water, and a conventional vortex tube. This reduces the scale significantly.

German Published, Non-Prosecuted Patent Application DE 38 36 461 A1, Low temperature steam generator, discloses a low temperature steam generator having a vertical cylindrical casing which is subdivided into an upper chamber and a lower chamber through the use of a horizontal partition. A hot liquid flows into the upper chamber to form a rotational flow. The liquid flows through an orifice in the partition into the lower chamber and at the same time is accelerated. As a result of the acceleration, the pressure in the liquid decreases, and steam is generated, which is discharged vertically upward from the upper chamber. The liquid leaves the chamber out of the lower chamber.

The German Published, Non-Prosecuted Patent Application DE 38 36 461 A1 teaches the generated steam is not present as hot dry steam. The flow from a pressurized boiling water reactor core is 546.8° F. (286° C.) at 1,015 psia (70 bar) which is saturated wet steam. This Application must add a step to preheat the flow to superheated steam before being fed to a steam turbine. My invention uses an input of pressurized non-boiling liquid water and does not require the extra heat needed to produce superheated steam as the German Application teaches. My invention produces superheated steam directly from one of the two vortex tube outlets.

German patent 151 464, Converting saturated steam into superheated steam, discloses an apparatus for converting saturated steam into superheated steam. In that apparatus, steam is set in a rotational flow with the aid of a screw disposed in a casing. Condensate is generated, which flows downward off the inside surface onto the screw threads as the result of gravity. The screw has a hollow cylinder inside it, into which the steam can enter through slits the steam flow vertically upward in the hollow cylinder and leaves the apparatus as superheated steam through a slide.

German patent 151 464 teaches the advantage of superheating steam can be seen in the fact that the effect is achieved on the basis of physical changes of state of the steam without external energy sources. My invention uses pressurized non-boiling liquid water and does not require the extra heat needed to produce steam as the German patent 151 464 teaches.

German patent 151 464 teaches the apparatus for converting saturated steam into superheated steam has a screw thread disposed in the annular space between the casing and concentrically placed hollow cylinder. This screw thread initiates a rotational liquid flow as the result of gravity. My invention initiates a rotational flow by pressurized liquid flow entering tangentially into a hollow cylinder approximately 90° to the axis of rotation. A high rotational velocity is developed that is not dependent on gravity as the German patent 151 464 teaches.

U.S. Pat. No. 5,996,350, Method and apparatus for the superheating of steam, discloses a method for the superheating of steam, which comprises at least partially converting a pressure energy of steam into a rotational flow about an axis of rotation and into an axial flow superposed on the rotational flow and flowing in direction of the axis of rotation; increasing a rotational velocity of the steam in the direction of the axis of rotation by reducing a flow cross-section while generating condensate and residual steam; separating the condensate from the residual steam upstream of the reduction of the flow cross-section and subsequently discharging the condensate essentially radially outward; and further conveying the residual steam in the direction of the axis of rotation while reducing the rotational velocity of the residual steam and superheating and converting the residual steam into hot steam.

The U.S. Pat. No. 5,996,350 teaches the advantage of superheating steam can be seen in the fact that the effect is achieved on the basis of physical changes of state of the steam without external energy sources. Also, the patent claims, the same effect can be achieved using boiling water in place of steam. My invention uses pressurized non-boiling liquid water and does not require the extra heat needed to produce steam or boiling water as the U.S. Pat. No. 5,996,350 teaches.

The U.S. Pat. No. 5,996,350 teaches the condensate is centrifuged off from the residual steam fraction which is not condensed out, as a result of the rotational flow and is subsequently discharged radially outward. My invention precipitates out condensate inwardly, not centrifuges off radially outward; my invention also disposes the condensate inwardly, not radially outward as the U.S. Pat. No. 5,996,350 teaches.

### SUMMARY

The present invention is generally directed to various systems and methods for producing electrical or mechanical power using a heatless “flashing” process that instantly creates a completely dry vapor from a compressed liquid refrigerant, bypassing the addition of “Latent Heat” to effect the vexing phase change of a liquid starting from the liquid bubble point and continuing until a completely dry vapor is created. The process

1) instantly resets the initial fluid state to a more desirable higher-temperature vapor stream state that flows directly into the turbine to generate power, and

2) also creates a large flow rate of a waste return compressed cool liquid stream that, upon its exit, mixes with the superheated exhaust stream (vapor) returning from the turbine. Its attributes of a large flow rate and the cooler temperature (lower than the vapor) result in a mixture which is much cooler than the exhaust stream, thus resulting in an excellent environmental bonus: less heat is now released into the environment.

Note that the compressed liquid flow stream is a liquid ready for pumping to a higher pressure, as in FIGS. 9 and 10, with minimum power input. In various illustrative examples, the devices employed in practicing this present invention include a changed rudimentary Rankine Cycle, FIG. 5, consisting of: a liquid feed pump, boiler or vaporizing heat exchanger, conventional counter-flow vortex tube, a turbine, and a condenser, all configured to produce electrical, mechanical or motive power, without adding “Latent Heat” to “flash” the compressed liquid refrigerant in the vaporizing heat exchanger or without adding “Latent Heat” to “flash” water in a boiler. One of the subject matters of this invention is: how to create dry vapor (technically a supercritical vapor) directly from a compressed liquid (technically a subcooled liquid), using the least amount of heat.

An objective of this invention is to produce electrical power using the heatless “flashing” process that instantly creates a completely dry vapor from a compressed liquid refrigerant and it obviates “Latent Heat.” For a conventional Organic Rankine Cycle power generating set, sufficient amounts of transferable heat are fed into the vaporizing heat exchanger to “flash” the refrigerant passing through the vaporizing heat exchanger to produce dry refrigerant vapor. The conventional process of “flashing” a liquid, FIG. 1, involves changing the liquid starting from the Step 1) liquid bubble point, Step 2) to a slow boil, Step 3) to a robust boil, Step 4) to a wet vapor, and finally Step 5) to a dry vapor which demands copious amounts of transferable heat. Waste heat, solar heat, geothermal energy, or fuel combustion all provide the transferable heat for the five conventional “flashing” process steps. This invention's heatless “flashing” process for refrigerants, FIG. 2, provides the desired dry vapor instantly avoiding three conventional steps of flashing:
bringing the liquid Step 2) to a slow boil; Step 3) to a robust boil; and Step 4) to a wet vapor, as well as the heat required for these steps;
adding the Step 6) of increasing the temperature of the dry vapor (a step not normally added in the conventional flashing process). The conventional vaporizing heat exchanger that produces the desired dry refrigerant vapor is replaced with the combination of a thermostat controlled refrigerant heater and a vortex tube; note the change between FIG. 5 and FIG. 6. For the vortex tube to separate the compressed liquid high and low liquid energy levels, the liquid state at pressure and temperature to be separated must be compressible. All refrigerants generally are known to be highly compressible. Compressibility is defined as the property of a material that measures its susceptibility to decrease in volume when an increase in pressure is experienced.

This specification teaches the steps of the invention's heatless “flashing” process, FIG. 2, is a schematic design depicting the Hardgrave process for vaporizing a heated compressed liquid refrigerant stream is: 1) pump the subcooled liquid refrigerant stream to a desired pressure; 2) provide the compressed liquid (technically a subcooled liquid) stream into a heat exchanger; 3) impart heat to the compressed liquid stream to raise the temperature, but not vaporize the liquid stream, until stream temperature is near the liquid bubble point temperature for the desired pressure; 4) provide this hot compressed liquid stream to a conventional counter-flow vortex tube to separate the hot compressed liquid stream into a cool compressed liquid stream and the desired dry refrigerant vapor stream, without the addition of heat. The dry refrigerant vapor stream is provided at a higher temperature than the liquid bubble point temperature; 5) provide the dry refrigerant vapor stream to drive a turbine.

Conventional Organic Rankine Cycle power generating installations usually convert less than 50% of their heat into electricity, with most of the waste heat being released through the condenser. “Latent Heat” accounts for over 50% of the heat required to create completely dry vapor. The major portion of the 50% loss of heat converting to electricity is due to supplying “Latent Heat.” Therefore, FIG. 2, this invention is a process for “flashing” a refrigerant that eliminates the need for “Latent Heat” to produce completely dry steam.

This 50% loss of heat converting into electricity is true even though a well known pre-heating economizer is deployed between the feed pump and the thermostat controlled refrigerant heater. The turbine receives this super heated dry refrigerant vapor, causing it to expand or increase its volume as the vapor's pressure is lowered along its torturous path through the turbine, prying the turbine blades apart to accommodate its new volume causing the turbine to rotate before exiting as exhaust. It is this rotation that is used to rotate an electrical generator to produce electrical power.

Design FIG. 5: The heat source is 58,700 lbm/hr (120 gpm) of 170° F. hot water delivering 31.253 Btu/lbm input to 46,460 lbm/hr of refrigerant R245fa to obtain a heated compressed liquid initial state of 166.44° F./300 psia. This initial state is provided to a vortex tube that resets the initial state condition to 264.2° F./100 psia dry vapor at 30% diminished flow rate of 46,460 lbm/hr that is expanded by the turbine. The turbine inlet state condition is 264.2° F./100 psia dry vapor and the outlet state condition is 185.71° F./18.573 psia dry vapor at a diminished flow rate of 13,938 lbm/hr. The calculated power output is 66.32 kWe. The calculated power output is rerated by a 75% turbine efficiency and 91% generator efficiency, less the feed pump of 8.4 kWe resulting in a net output of 36.866 kWe. The waste heat loss during cooling water condensing is 45.375 Btu/lbm or 2.1 M Btu/hr. The avoided “Latent Heat” is 67.446 Btu/lbm used conventionally to develop dry vapor.

Design FIG. 6: The addition of the economizer between the feed pump and the thermostat controlled refrigerant heater reduces the heat input and the waste heat loss. The input is reduced from 31.2529 Btu/lbm to 23.331 Btu/lbm at 46,460 lbm/hr of R245fa. The waste heat is also reduced to 37.5217 Btu/lbm or 1.75 M Btu/hr. The avoided “Latent Heat” is 67.446 Btu/lbm.

Design FIG. 7: The heat source is 58,700 lbm/hr (120 gpm) of 170° F. hot water delivering 31.253 Btu/lbm input to 46,460 lbm/hr of refrigerant R245fa to obtain a heated compressed liquid initial state of 166.44° F./300 psia. This initial state is provided to the first vortex tube that resets the initial state condition to 264.2° F./100 psia dry vapor at 30% diminished flow rate of 46,460 lbm/hr that is expanded by the turbine. The first turbine inlet state condition is 264.2° F./100 psia dry vapor and the outlet state condition is 185.71° F./18.573 psia dry vapor at a diminished flow rate of 13,938 lbm/hr. The calculated power output of the first turbine is 66.32 kWe. The initial state provided to the second vortex tube resets the initial state condition to 125.6° F./100 psia dry vapor at 30% diminished flow rate of 32,522 lbm/hr that is expanded by the turbine. The second turbine inlet state condition is 125.6° F./100 psia dry vapor and the outlet state condition is 198.22° F./18.573 psia dry vapor at a diminished flow rate of 9,756.6 lbm/hr. The calculated power output of the second turbine is 16.17 kWe for a total calculated power output of 82.49 kWe. The total calculated power output is rerated by a 75% turbine efficiency and 91% generator efficiency, less the single feed pump of 8.4 kWe resulting in a net output of 47.9 kWe. The waste heat loss during cooling water condensing is 58.7 Btu/lbm or 2.73 M Btu/hr. The avoided “Latent Heat” is 67.446 Btu/lbm used conventionally to develop dry vapor.

Design FIG. 8: The addition of the economizer between the feed pump and the thermostat controlled refrigerant heater reduces the heat input and the waste heat loss. The input is reduced from 31.2529 Btu/lbm to 17.16 Btu/lbm at 46,460 lbm/hr of R245fa. The waste heat was also reduced to 44.72 Btu/lbm or 2.08 M Btu/hr. The avoided “Latent Heat” is 67.446 Btu/lbm. This design yields the most power output, 47.9 kWe, for the least environmental impact of 2.08 M Btu/hr, at 43.376 kBtu/hr per kWe.
Hot water supply flow rate 120 gpm [7.6 l/s] at different Inlet Temperatures
This table displays gross power output for five different designs
Water cooled condensing system
Cooling water inlet conditions: 70° F. [21° C.]/220 gpm [13.9 l/s]

| | Inlet | Cal Power | Net Power | Input | Heat (h) into |
|---|---|---|---|---|---|
| FIGS. | Temp (° F.) | (kWe) | (kWe) | Heat (h) | Environment |
| 5 | 170 | 66.325 | 36.860 | 31.253 | 45.375 |
| 6 | 170 | 66.325 | 36.860 | 23.331 | 37.522 |
| 7 | 170 | 82.496 | 47.897 | 31.253 | 58.700 |
| 8 | 170 | 82.496 | 47.897 | 17.160 | 44.725 |
| 9 | 170 | 112.752 | 64.080 | 44.674 | 64.552 |
| 5 | 150 | 63.998 | 35.272 | 24.269 | 39.427 |
| 6 | 150 | 63.998 | 35.272 | 17.827 | 32.977 |
| 7 | 150 | 79.655 | 45.958 | 24.269 | 46.092 |
| 8 | 150 | 79.655 | 45.958 | 10.316 | 41.782 |
| 9 | 150 | 108.797 | 61.495 | 37.210 | 58.984 |
| 5 | 120 | 60.162 | 32.654 | 14.323 | 30.427 |
| 6 | 120 | 60.162 | 32.654 | 10.010 | 26.131 |
| 7 | 120 | 75.561 | 43.164 | 14.323 | 52.349 |
| 8 | 120 | 75.561 | 43.164 | 3.488 | 43.322 |

In a conventional Rankine Cycle power plant, fuel is fed into a boiler, FIG. 3, for combustion to produce sufficient amounts of transferable heat to “flash” or vaporize the water passing through the boiler to dry steam. The amount of heat to effect this phase change, at constant pressure, is called “Latent Heat.” This “Latent Heat” accounts for over 50% of the heat required to create completely dry steam. The major portion of the 50% loss of the fuel energy is due to supplying “Latent Heat.” Therefore, FIG. 4, this invention is a process for “flashing” water that eliminates the need for “Latent Heat” to produce completely dry steam—resulting in a great savings in fuel.

This invention's heatless “flashing” process used by the changed Organic Rankine Cycle for refrigerants should be the same for use by a conventional Rankine Cycle power plant using water with one exception; the designer must assure that water is in a compressible inlet and separation state when transferred to the vortex tube for process separation.

### Properties of Water

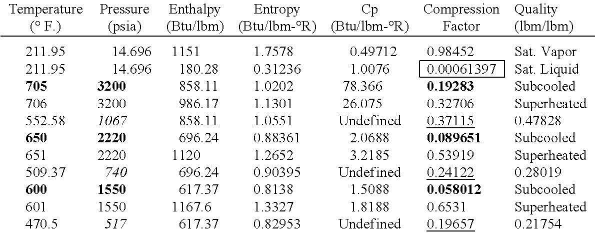

Water is known to be incompressible at atmospheric temperature and pressure as indicated by the boxed value in the table. But the initial state of water as a compressed (Subcooled) liquid within chosen conditions of temperature and pressure becomes slightly compressible as indicated by bolded values in the table. The bolded compression factors are of the same magnitude as those of the refrigerant R245fa for inlet conditions to the vortex tube. Note the compression factor increases as the condition state approaches the saturated vapor state. The actual separation occurs at a medium pressure (approximately 500 to 1,000 psia, note the italicized pressure values) amid a phase change for water (for example: 470.5° F./ 517 psia and 509.37° F./740 psia) from the liquid bubble point to a completely dry steam. As seen in the table, the compression factor is much higher and tends to aid the separation. Heating water to create steam takes an enormous amount of energy in the form of heat, and fuel to supply that heat.

### Counterflow Vortex Tube

To avoid any misunderstanding about what is used when calling for a vortex tube, a description of how this preferred vortex tube works is included. Also, the description of how the preferred vortex tube works is included to make its use certain in the applications of this invention.

The process of producing hot dry steam from pressurized hot liquid water within a Counterflow Vortex Tube:

### Inlet Chamber

Pressurized hot liquid water is fed through at least one tangential nozzle approximately perpendicular to the axis of rotation of the chamber's rotational flow. This induces a spin as it enters tangentially into a cylindrical internal counterbore cut within the inlet chamber. The pressure gradient through the nozzle(s) creates a change of state of the hot liquid and sets in motion the expansion of the hot water and the acceleration of the flow entering the inlet chamber. In order to convert as high a fraction of the entering pressure energy as possible into kinetic energy, the vortex tube inlet is advantageously constructed as a simple nozzle such as a de Laval Nozzle. A de Laval Nozzle is a tube that is pinched in the middle making a carefully balanced, asymmetric hourglass-shape used to accelerate the hot liquid water through the pinched area, expanding of the stream through the diverging nozzle outlet, continuing to accelerate the straight line forward velocity entering the inlet chamber.

As a result of this straight line acceleration, both the hot liquid water temperature and pressure decrease, causing a generation of wet steam, changing the state of the hot stream to a liquid plus a wet steam. The duel phase stream is mechanically forced to follow the inside counterbore diameter of the inlet chamber converting the hot water flow pressure energy into rotational flow energy about an axis of rotation; it spins creating a swirling flow being pushed forward by the incoming hot liquid water fed through at least one tangential nozzle into the inlet chamber. This duel phase fluid partially converts its pressure energy into; a) forced rotational flow accelerating about an axis of rotation and into; b) forward axial flow superposed on the rotational flow. The rotational flow always accelerates because the straight line flow velocity from the nozzle is being forced to change direction to follow the inside diameter of the inlet chamber, forming an arch of angular acceleration. The pressure energy of the duel phase fluid flow is converted into rotational flow kinetic energy while within the inlet chamber. Some of the nozzle(s) hot liquid water fraction converts to wet steam because of the wet steam's rotational (angular) acceleration and expansion, where both the pressure and the temperature decrease within the inlet chamber. The liquid fraction becomes colder and the steam fraction becomes hotter and dryer.

A velocity has both speed and direction. To analyze the fluid velocity within the vortex tube, the two components present are to be investigated:
1) Straight line velocity—Speed plus forward direction
2) Rotating velocity—Speed plus changing direction forming an arc path (Note: the rotating velocity is always accelerating because the direction is continually changing to form an arc path.) When these two velocities combine, the result is the true flow velocity that follows a helical path, e.g., similar to a coiled spring.

The pressurized hot liquid water entering the vortex tube causes a pressure gradient, from inlet to outlet, that pushes the swirling flow forward. The diminishing pressure gradient causes the swirling flow to expand along its forward movement path. The expanding hot liquid exiting the nozzle experiences a drop in the fluid temperature and pressure, as well as straight line forward velocity acceleration. A change in the stream's state and the forced rotation sets in motion an efficient energy conversion.

The pressure gradient pushes the duel phase fluid's steam fraction out of the inlet chamber. However, the tube inlet constitutes a barrier for the duel phase fluid to overcome in order to leave the inlet chamber. The rotational flow's angular momentum must be maintained as this rotational flow enters the tube. Due to the narrowing of the tube flow cross-section, the rotational velocity of the rotational flow increases as a consequence of the principle of conservation of angular momentum: the closer the steam approaches the axis of rotation, the higher its circumferential velocity becomes and the more pressure energy is converted into kinetic energy. Conversely, kinetic energy can be converted back into pressure again by leading the steam further away from the axis of rotation.

Once a swirling rotational flow develops, the change in temperature as well as the high-speed fluid flow of revolution makes it impossible for all water droplets to be carried along with this accelerating rotating flow. The separation occurs due to the difference in the angular momentum of the liquid water and the wet steam. As a result of the decrease in temperature and rotating flow acceleration, both wet steam and liquid water fractions are present. Therefore, at this new state, liquid water as well as condensate will drop out of the rotating flow within the inlet chamber because the angular momentum of a liquid is less than that of steam.

As the swirling rotational flow moves forward in the cylindrical internal counterbore within the inlet chamber, liquid condensate drops out of the wet steam due to the lower temperature which is then present emitting condensation heat, leaving its condensation heat which is absorbed by the wet steam while forming condensate. A vacuum prevails in the central region of the rotational flow encompassing the orifice outlet of the inlet chamber which attracts the slower rotating condensate and any liquid fraction. All of the liquid condensate is blasted from inside of the inlet chamber internal counterbore by the rotational flow's high velocity and accumulates in the central vacuum region of the rotational flow near the inlet chamber orifice outlet. The liquid leaves the inlet chamber by being swept away by a swirling counterflow exiting the vortex tube orifice outlet (cold) leaving condensation heat that is absorbed by the generated wet steam. Since the residual steam can now no longer transfer this previously absorbed condensation heat to the condensate which has been separated, the residual steam is heated and is present as hot steam. The temperature of the heated generated steam essentially becomes higher and a more complete conversion of pressure energy into kinetic energy. A result is lower moisture content of the heated steam or drying the wet steam.

During condensation, the condensate emits condensation heat. Condensation heat has to be released in order to create a liquid condensate. Rotating angular momentum is lost from the liquid condensate fraction and the lost energy shows up as heat in the swirling outer edge steam fraction. The condensation heat can't be transferred back to the liquid from whence it came because the liquid isn't present. Wet steam absorbs the heat and becomes dryer hot steam. The heated steam expands from the heat as well as the diminishing pressure gradient, causes the rotating velocity to accelerate even faster. As the heated swirling steam moves forward to its outer edges inside the cylindrical counterbore within the inlet chamber, it displaces the slower cooler liquid enabling a migration of the cooler liquid and steam to the cooler low pressure center of the swirl. With its new found heat, the outer swirl becomes faster; then the outer edges of the swirling steam expands even more, becoming hotter and dryer. Thus, the outer edge steam becomes hot, and the low pressure center of the swirl becomes cool.

The separation of liquid and steam within the inlet chamber:
1) the straight line hot fluid from at least one nozzle expands,
2) the straight line hot fluid from at least one nozzle accelerates,
3) the rotating fluid temperature and pressure both drop,
4) the rotating fluid velocity accelerates following the inlet chamber internal counterbore,
5) condensate forms and drops out of the accelerating rotating fluid, emitting condensation heat,
6) the liquid water as well as condensate are swept away by a swirling counterflow center vortex,
7) the rotating wet steam absorbs the heat left behind,
8) the rotating steam becomes heated,
9) the rotating heated steam's increased rotational velocity allows a reduced spin diameter,
10) the rotating heated steam is pushed forward from the inlet chamber into the smaller tube inside diameter.

In a well functioning inlet chamber, all liquid is left in the inlet chamber while the rotating heated steam is pushed forward into the tube. Wet steam is prevented from entering the tube until the steam temperature is great enough to enable a smaller diameter higher rotational velocity to continue its rotational flow inside the tube, while maintaining angular momentum. The swirling heated steam cloud is pushed by the diminishing pressure gradient into the reduced tube flow cross-section all the while generating additional condensate and wet steam as it moves forward. The swirling heated steam cloud enters the tube passing through a narrow annulus ring area formed between the swirling counterflow center vortex and the smaller tube inside diameter. The condensate is striped from the center of the swirling heated steam cloud by the swirling counterflow center vortex leaving only steam entering the tube.

### Tube

Some vortex tubes do not have an inlet chamber as described and the pressurized hot liquid water is fed tangentially through the tube wall approximately perpendicularly to the axis of rotation of the tube's rotational flow. The separation of energy would start at this point in the process.

Continuing, the swirling heated steam cloud enters the tube passing through a narrow annulus ring area formed between the swirling counterflow center vortex and the tube inside diameter. The steam will not be enabled to enter the tube, for a given angular momentum, until the temperature is great enough to allow a higher rotational velocity steam, a dryer steam, to continue at near the same angular momentum within the tube. An increase in the rotational velocity is farther achieved and maintained by the reduction of the flow cross-section. The area oriented perpendicularly to the axis of rotation is designated as the flow cross-section. The steam continues to expand creating a swirling heated steam cloud as it exits the inlet chamber into the smaller flow cross-section tube. After the liquid in the inlet chamber has been discharged, a portion of the swirling heated steam cloud pressure energy is converted into angular kinetic energy.

The diminishing pressure gradient pushes the swirling steam flow axially forward inside the tube as a swirling steam cloud expands, accelerates, then cools. The diminishing pressure gradient and dropping temperature triggers the swirling steam flow to expand along its forward movement path. Liquid water condenses from the swirling steam, emitting condensation heat, leaving its heat absorbed within the surrounding swirling steam. The heated expanding swirling steam fraction migrates outward separating from the non-heated swirling wet steam fraction as a result of the absorbed condensation heat enabling a higher (rotational flow) angular acceleration to be attainable by the higher temperature steam. The conservation of angular momentum is at play here, balancing the increased momentum of the heated swirling steam with the decreased momentum of the condensate. It is angular momentum that separates the swirling condensate from the swirling heated steam.

Rotating angular momentum is lost from the liquid condensate fraction and the lost energy shows up as heat in the swirling outer edge steam fraction. The condensation heat can't be transferred back to the liquid from whence it came because the liquid isn't present. The steam absorbs the heat and becomes dryer hot steam. The heated steam expands from the heat as well as the dropping pressure gradient, causes the rotating velocity to accelerate even faster.

Separating the condensate from the wet steam and subsequently displacing the condensate essentially forward within the tube by the diminishing pressure gradient creates three strata or layers, all rotational layer velocities generally moving forward in the same direction: 1) outer edge hot steam layer, 2) mid wet steam layer, and 3) inner condensate layer. The outer edge hot steam angular velocity is higher than the inner condensate angular velocity and the mid wet steam layer angular velocity value is between the two. The mid wet steam layer forward velocity is higher than the inner condensates angular velocity and the outer edge hot steam forward velocity. The close relative proximity of the three layers is imperative for the tube to function as intended; therefore, a small tube is needed, not a tube inside diameter as large as the counterbore.

The heated steam moving outward is enabled to achieve the higher rotational velocities. The higher rotational steam flow velocity is accelerated generating a swirling steam cloud which continues to expand moving axially forward within the tube resulting in both the pressure and the temperature of the swirling cloud to be further reduced, and even more liquid condensate drops out of the swirling steam cloud within the tube. The entry of the steam into the tube assists a buildup of rotational flow and the conversion of pressure energy into kinetic energy. The condensate from the swirling steam is subsequently displaced inward towards the central region vacuum of the swirl. The condensation heat has to be released in order to create a liquid.

The principle of the conservation of rotating momentum is prominent in the function of a vortex tube: the rotational speed of the swirling steam fraction is to increase because of its absorbed heat; whereas, the rotational speed of the liquid condensate fraction decreases to keep the gain/loss balance in momentum. The rotating condensate fraction momentum has to be lower because of its loss of heat. This causes a liquid migration that can't go anywhere but inside the low-pressure center of the swirling steam (temporarily). The separation of the hot from cold is how the separation of energy is accomplished.

The separation of energy process within the tube:
1) the rotating steam temperature and pressure both drop,
2) the rotating steam expands by reducing the pressure and absorbing the condensation heat,
3) the rotating steam velocity accelerates about a rotational axis,
4) a condensate forms and drops-out, because of conservation of angular momentum, emitting condensation heat,
5) condensate is discharged along with the swirling center counterflow exiting the vortex tube,
6) the rotating steam absorbs the condensation heat left behind, and
7) the rotating heated steam is dryer and superheated as it migrates outward,
1) the rotating steam expands.

The process repeats.

The tube length enables a substantial amount of the rotating steam entering the tube to absorb condensation heat and be transformed into superheated steam; allowing the steam cloud to expand the full length of the tube increasing the time the steam has to expand. The amount of residual moisture becomes incrementally lower as the rotational velocity of the rotational flow becomes higher. The temperature of the heated generated steam essentially becomes higher the more complete the conversion is of pressure energy into kinetic energy and the moisture content becomes lower within the rotating steam. The suggested length is between 6 to 7 feet in length for this application.

A fraction of the swirling steam cloud moving forward axially to the hot end of the vortex tube deflects reversing the forward flow, folding back and disappearing into its low pressure center, forming a rotating counterflow axial component of the velocity moving backward from the hot end of the vortex tube to the cold end. As the swirling steam reaches the tube end, the cooler rotating center meets the blunt end of the tube. A valve downstream of the blunt end at the hot end of the tube allows some of the hot dry steam to escape. Only the superheated outer edge of the swirling steam can exit. What does not escape, heads axially back down the tube as a cold counterflow vortex inside the low-pressure center of the outer hot swirling steam creating a counterflow core that rotates slower in unison as a solid in the opposite direction of the hot swirling steam. This counterflow vortex loses heat sweeping up the liquid condensates encountered along its way back and exhausts through the vortex tube cold end orifice as a cooler fluid (almost all liquid) ready to pump.

### DESCRIPTION OF DRAWINGS

FIG. 1 is a process map of a conventional liquid refrigerant flashing process.

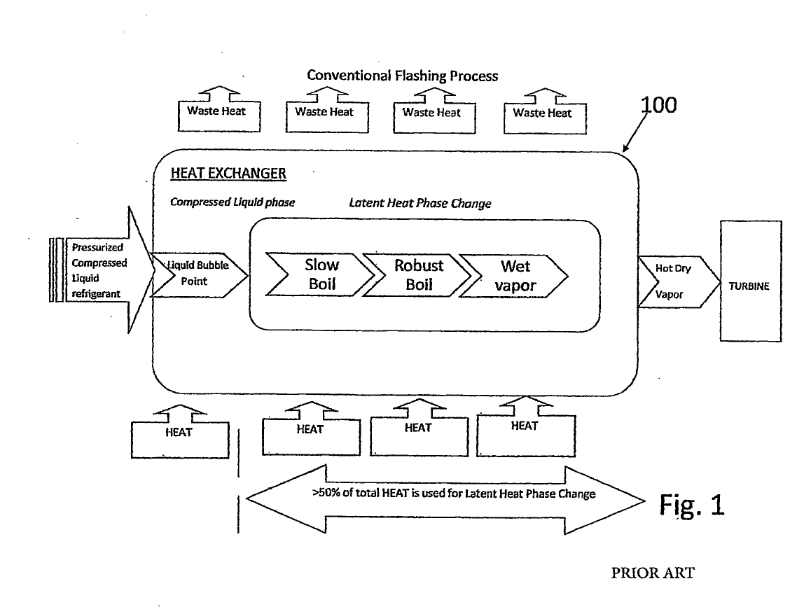

FIG. 2 is a process map of a heatless liquid refrigerant flashing process.

FIG. 3 is a process map of a conventional steam power plant water flashing process.

FIG. 4 is a process map of a steam power plant heatless water flashing process.

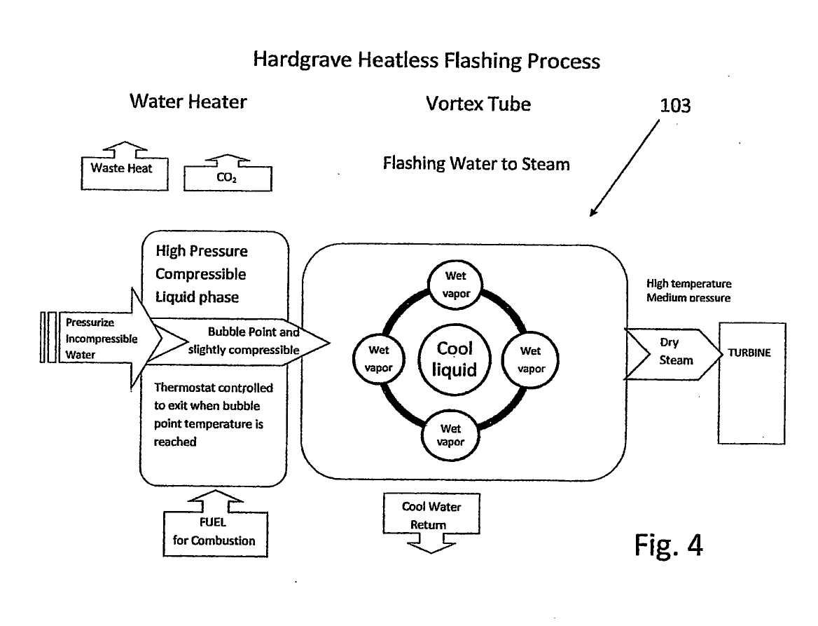

FIG. 5 is a schematic design of rudimentary Rankine Cycle with vortex tube.

FIG. 6 is a schematic design Rankine Cycle with vortex tube and economizer.

FIG. 7 is a schematic design Rankine Cycle with two vortex tubes and two turbines.

FIG. 8 is a schematic design Rankine Cycle with two vortex tubes and two turbines and economizer.

FIG. 9 is a schematic design Rankine Cycle with two feed pumps, two vortex tubes, and two liquid heaters.

FIG. 10 is a schematic design Rankine Cycle with two feed pumps, two vortex tubes, two liquid heaters, and economizer

### DETAILED DESCRIPTION OF THE INVENTION

The present invention is directed to a process for creating a supercritical vapor from a subcooled liquid without adding the “latent-heat” to effect the vaporization of the subcooled liquid. At its beginning state, subcooled liquid is pumped into the vaporizing heat exchanger to add heat. The process flow control ensures the pressurized subcooled liquid remains a subcooled liquid as heat is continually added. The heat transferred to raise the temperature of the subcooled liquid produces a hot subcooled liquid near the saturated liquid inlet temperature. With respect to these conditions, the vortex tube separation process of a subcooled liquid assures the production of two outflows: 1) a supercritical vapor stream and 2) a subcooled liquid stream. The supercritical vapor stream continues routing with the process, and the subcooled liquid stream, while returning to its beginning state for further cycling, retains a residual energy as well as a value for cooling.

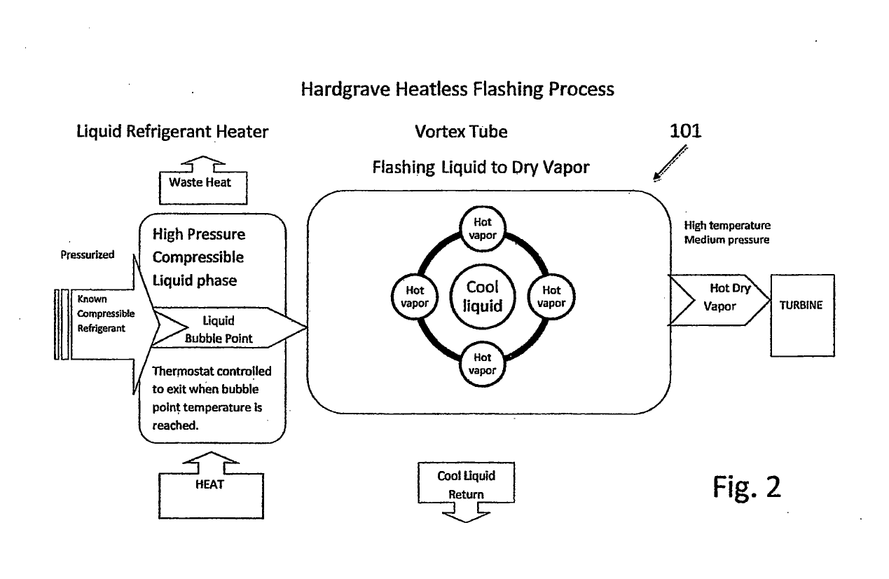

The present invention shown in FIG. 2 is a schematic map depicting the Hardgrave process for vaporizing a subcooled liquid refrigerant stream:
1) pump the subcooled liquid refrigerant stream to the desired pressure;
2) provide the pressurized subcooled liquid stream into a heat exchanger;
3) transfer heat from an external heat source to the pressurized subcooled liquid stream passing through the heat exchanger raising the stream temperature, but not vaporizing the liquid stream, until the stream temperature is near the saturated liquid inlet temperature for the desired pressure;
4) feed this hot pressurized subcooled liquid stream into a conventional counter-flow vortex tube to separate the hot pressurized subcooled liquid stream into two outflows:
   a) a cool subcooled liquid stream and
   b) the desired supercritical refrigerant vapor stream, without the addition of “Latent Heat.”

The supercritical refrigerant vapor stream created by the vortex tube has developed a higher temperature state than the saturated liquid inlet temperature;
5) provide the supercritical refrigerant vapor stream to convert the heat energy into a work, electrical or motive force.

The supercritical vapor exhaust stream and the cool subcooled liquid stream are mixed resulting in a cool mixture stream returning to their original state for further cycling.

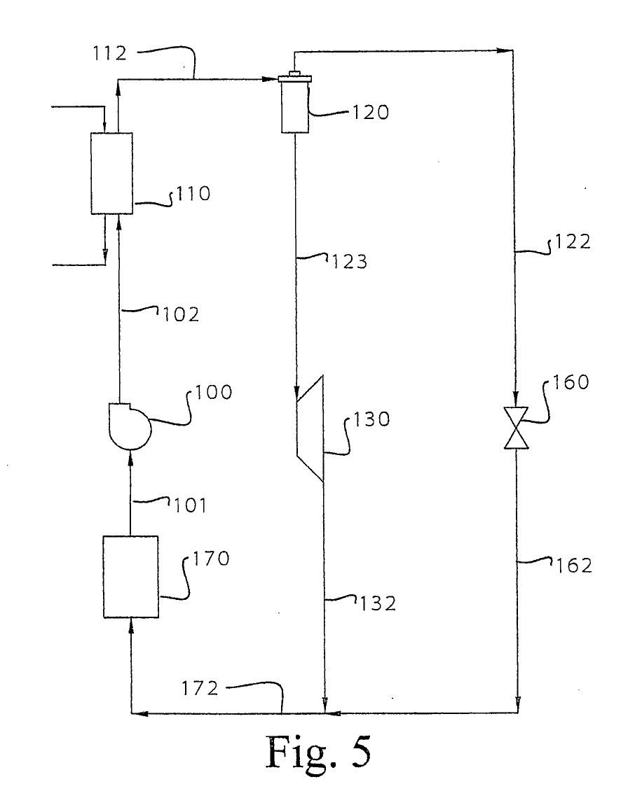

The invention shown is the rudimentary Rankine Cycle with vortex tube 120. FIG. 5 is the basic schematic design for a heatless flashing process used to produce electrical power. It is the starting point for all of the five following schematic designs.

The present invention shown in FIG. 5, is a schematic design depicting the Hardgrave process for vaporizing the subcooled liquid refrigerant stream 112 to produce electricity:
use feed pump 100 to pump the subcooled liquid refrigerant stream 101 to the desired pressure;
flow the pressurized subcooled liquid stream 102 into a heat exchanger 110;
transfer heat from an external heat source to the subcooled liquid stream 102 to raise its temperature, but not vaporize the subcooled liquid stream 102, until stream 102 temperature is near the saturated liquid inlet temperature for the desired pressure; feed this hot subcooled liquid stream 112 into the inlet of a conventional counter-flow vortex tube 120 to separate the hot subcooled liquid stream 112 into two outflows: a cool subcooled liquid stream 122; and the desired supercritical refrigerant vapor stream 123, without the addition of “Latent Heat.” The supercritical refrigerant vapor stream 123 is provided at a higher temperature than the saturated liquid inlet temperature and the supercritical refrigerant vapor stream 123 is used to drive a turbine 130 to produce electricity or convert the heat energy into a work, electrical or motive force.

The subcooled liquid stream 122 retains a residual energy and value for cooling while returning to its state of beginning for further cycling. The cool subcooled liquid stream 122 is fed into a Joule-Thomson device 160 emerging with lower temperature and pressure as feed stream 162. The temperature and pressure of stream 123 is lowered when it emerges from the turbine 130 as supercritical vapor feed stream 132 which is mixed with the cool subcooled liquid feed stream 162, yielding a cool mixed stream 172 that is fed into a condenser 170. Emerging as the condensed subcooled liquid refrigerant stream 101 that is transmitted from the condenser 170 at a lower temperature, and is fed into pump 100, the place of beginning, completing the cycle.

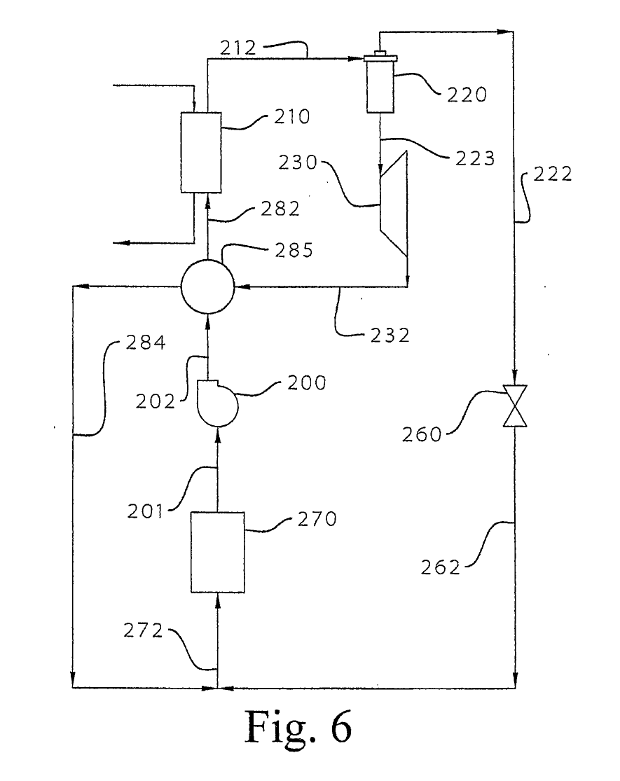

This invention shown is the same as the rudimentary Rankine Cycle with vortex tube 220, FIG. 5, with the addition of an economizing heat exchanger 285. FIG. 6, is a schematic design depicting the Hardgrave process for vaporizing the subcooled liquid refrigerant stream 212 to produce electricity: use feed pump 200 to pump the subcooled liquid refrigerant stream 201 to a desired pressure; feed the pressurized subcooled liquid stream 202 into an economizing heat exchanger 285 to be pre-heated; and flow the pre-heated pressurized subcooled liquid stream 282 into the heat exchanger 210. The pre-heating process reduces the amount of heat transferred from an external heat source thereby improving the heat efficiency.

Continuing the process, transfer heat from an external heat source to the pre-heated pressurized subcooled liquid stream 282 raising the stream 282 temperature, but not to the state of vaporizing the liquid stream 242, but only until the liquid stream 242 temperature is near the saturated liquid inlet temperature for the desired pressure; feed this hot pressurized subcooled liquid stream 212 into the inlet of a conventional counter-flow vortex tube 220 to separate the hot pressurized subcooled liquid stream 212 into two outflows: a cool subcooled liquid stream 222; and the desired supercritical refrigerant vapor stream 223, without the addition of “Latent Heat.”

The supercritical refrigerant vapor stream 223 is provided at a higher temperature than the saturated liquid inlet temperature and the supercritical refrigerant vapor stream 223 is used to drive the turbine 230 to produce electricity or convert the heat energy into a work, electrical or motive force.

The cool subcooled liquid stream 222 is fed into a Joule-Thomson device 260, emerging with lower temperature and pressure as feed stream 262. The temperature and pressure of stream 223 is lowered when it emerges from the turbine 230 as supercritical vapor feed stream 232.

Feed stream 232 is transmitted from the turbine 230 as a supercritical vapor into the economizing heat exchanger 285 to provide the heat for pre-heating the pressurized subcooled liquid stream 202. The temperature of supercritical vapor feed stream 232 is lowered when it emerges from the economizing heat exchanger 285 as feed stream 284.

Feed stream 284 is mixed with feed stream 262, resulting in a cooler mixed stream 272 that is fed into a condenser 270. The condensed subcooled liquid refrigerant stream 201 is transmitted from the condenser 270 at a lower temperature, and is fed into pump 200, the place of beginning, completing the cycle.

The invention shown is the same as the rudimentary Rankine Cycle with vortex tube 320, FIG. 5, with an alteration of the cool subcooled liquid return stream's 322 use rather than just returning to its state of beginning for further cycling. This invention is designed to use its residual energy before the return of the subcooled liquid stream 322 by adding a second vortex tube 330 and turbine 350.

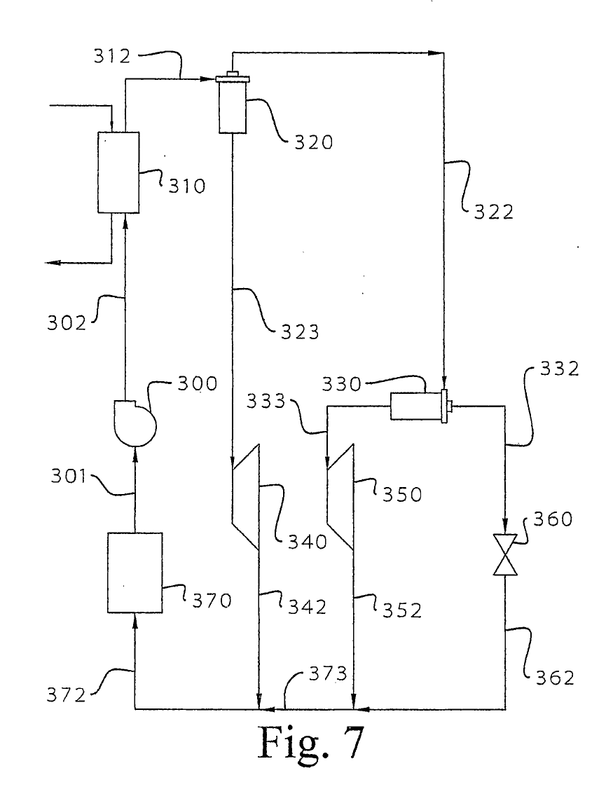

FIG. 7, is a schematic design depicting the Hardgrave process for vaporizing the supercritical liquid refrigerant stream 312 to produce electricity: use feed pump 300 to pump the subcooled liquid refrigerant stream 301 to the desired pressure; provide the pressurized subcooled liquid stream 302 into a heat exchanger 310; transfer heat from an external heat source to the pressurized subcooled liquid stream 302 to raise its temperature, but not vaporize the liquid stream 302, until stream 302 temperature is near the saturated liquid inlet temperature for the desired pressure; feed this hot pressurized subcooled liquid stream 312 into the inlet of a first conventional counter-flow vortex tube 320 to separate the hot pressurized subcooled liquid stream 312 into two outflows: a first cool subcooled liquid stream 322; and the desired first supercritical refrigerant vapor stream 323, without the addition of “Latent Heat.”

The first supercritical refrigerant vapor stream 323 is provided at a higher temperature by the vortex tube 320 than the saturated liquid inlet temperature for the desired pressure;
provide the first supercritical refrigerant vapor stream 323 to drive a turbine 340 to produce electricity or convert the heat energy into a work, electrical or motive force.

Feed the first cool subcooled liquid stream 322 into the inlet of a second conventional counter-flow vortex tube 330 to separate the first cool subcooled liquid stream 322 into a second cool subcooled liquid stream 332; and the second supercritical refrigerant vapor stream 333, without the addition of “Latent Heat.”

The electric power output of second turbine 350 can also be increased minutely if the pressure of the first cool subcooled liquid stream 322 is increased by a second liquid feed pump 390 (not shown) prior to being fed into a second conventional counter-flow vortex tube 330.

The second supercritical refrigerant vapor stream 333 is provided at a higher temperature than the saturated liquid inlet temperature for its chosen pressure, provide the second supercritical refrigerant vapor stream 333 to drive a turbine 350 to produce electricity or convert the heat energy into a work, electrical or motive force.

The second cool subcooled liquid stream 332 is fed into a Joule-Thomson device 360 emerging with lower temperature and pressure as feed stream 362. The temperature and pressure of stream 323 is lowered when it emerges from the turbine 340 in feed stream 342. The temperature and pressure of stream 333 is lowered when it emerges from the turbine 350 in feed stream 352. Feed streams 352 and feed stream 362 are mixed forming feed stream 373, which is mixed with feed stream 342, the combined stream 372 is transmitted into the a condenser 370. The condensed subcooled liquid refrigerant stream 301 is transmitted from the condenser 370 at a lower temperature, and is fed into pump 300, the place of beginning, completing the cycle.

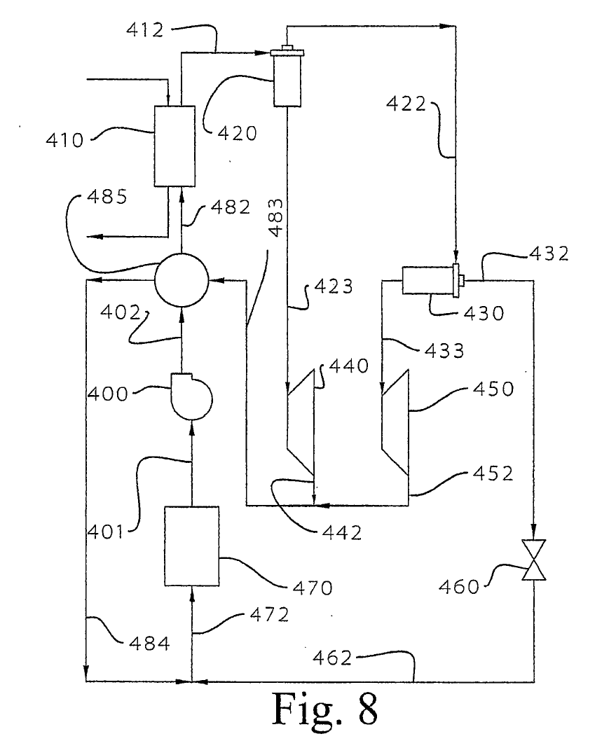

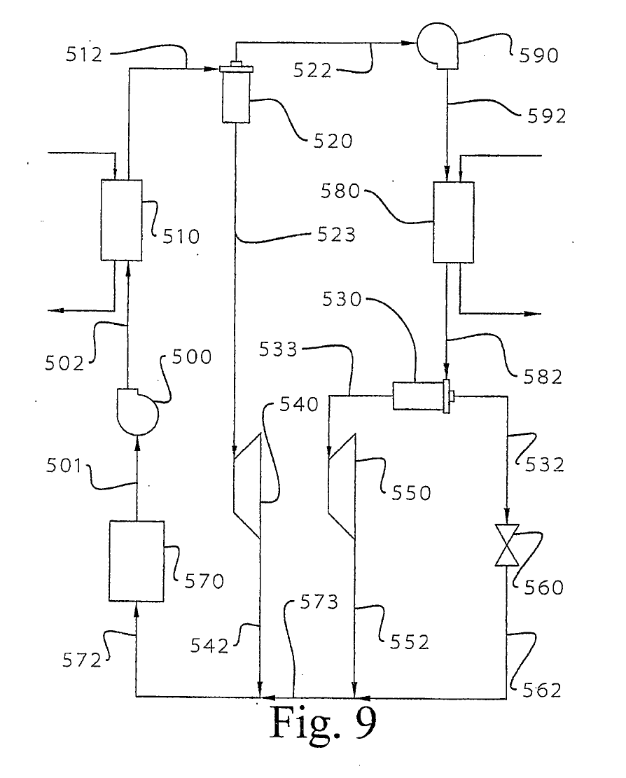

The invention shown as FIG. 8, is the same as the rudimentary Rankine Cycle with vortex tube 420, FIG. 9, with the addition of an economizing heat exchanger 485 and an alteration of the cool subcooled liquid return stream 422.

There are two positions for the addition of an economizing heat exchanger 485. The position chosen is between the feed pump 400 and the heat exchanger 410 to pre-heat the pressurized subcooled liquid stream 402 before being introduced into the heat exchanger 410. This position for the pre-heating process reduces the amount of heat transferred from an external heat source, thereby improving the heat efficiency.

The alternate position for the addition of an economizing heat exchanger 485 is between the first conventional counter-flow vortex tube 420 and the second conventional counter-flow vortex tube 430 to pre-heat the first cool subcooled liquid stream 422 before being introduced into the inlet of the second conventional counter-flow vortex tube 430. This position for the pre-heating process increases the power output of the second turbine 450 not chosen.

The altered use of the cool subcooled liquid return stream 422 is to produce power, by adding a second vortex tube 430 and a second turbine 450, from the cool subcooled liquid return stream 422 residual energy, rather than just returning to its state of beginning for further cycling, as shown in this invention.

FIG. 8, is a schematic design depicting the Hardgrave process for vaporizing a pressurized subcooled liquid refrigerant stream 412 to produce electricity: use feed pump 400 to pump the subcooled liquid refrigerant stream 401 to a desired pressure; provide the pressurized subcooled liquid stream 402 into an economizing heat exchanger 485 to be pre-heated and provide a pre-heated pressurized subcooled liquid stream 482 into a heat exchanger 410; transfer heat from an external heat source into the pressurized subcooled liquid stream 482 to raise the temperature, but not vaporize the liquid stream 482, until stream 482 temperature is near the saturated liquid inlet temperature for the desired pressure; provide this hot pressurized subcooled liquid stream 412 into the inlet of a first conventional counter-flow vortex tube 420 to separate the hot pressurized subcooled liquid stream 412 into two outflows: a first cool subcooled liquid stream 422; and the desired first supercritical refrigerant vapor stream 423, without the addition of “Latent Heat.” The first supercritical refrigerant vapor stream 423 is provided at a higher temperature than the saturated liquid inlet temperature for the desired pressure and the first supercritical refrigerant vapor stream 423 is used to drive a turbine 440 to produce electricity or convert the heat energy into a work, electrical or motive force.

Feed the first cool subcooled liquid stream 422 into the inlet of a second conventional counter-flow vortex tube 430 to separate the first cool subcooled liquid stream 422 into two outflows: a second cool subcooled liquid stream 432; and the second supercritical refrigerant vapor stream 433, without the addition of “Latent Heat.” The second supercritical refrigerant vapor stream 433 is provided at a higher temperature than the saturated liquid inlet temperature for its chosen pressure; provide the second supercritical refrigerant vapor stream 433 to drive a turbine 450 to produce electricity or convert the heat energy into a work, electrical or motive force.

The second cool subcooled liquid stream 432 is fed into a Joule-Thomson device 460 emerging with lower temperature and pressure as feed stream 462. The temperature and pressure of stream 423 is lowered when it emerges from the turbine 440 in feed stream 442, The temperature and pressure of stream 433 is lowered when it emerges from the turbine 450 in feed stream 452 which is mixed with feed stream 442.

The combined stream 483 is transmitted from the turbines 440 and 450 as a supercritical vapor into the economizing heat exchanger 485 to provide the heat for pre-heating the pressurized subcooled liquid stream 402. The temperature of feed stream 483 is lowered when it emerges from the economizing heat exchanger 485 as feed stream 484.

Feed stream 484 is combined with feed stream 462, the combined stream 472 is fed into a condenser 470. The condensed subcooled liquid refrigerant stream 401 is transmitted from the condenser 470 at a lower temperature, and is fed into pump 400, the place of beginning, completing the cycle.

The invention shown as FIG. 9, is the same as the rudimentary Rankine Cycle with vortex tube 520, as shown by FIG. 5, with the altered use of the cool subcooled liquid return stream 522. The altered use of the cool subcooled liquid return stream 522 residual energy is to produce power rather than just returning to its state of beginning for further cycling.

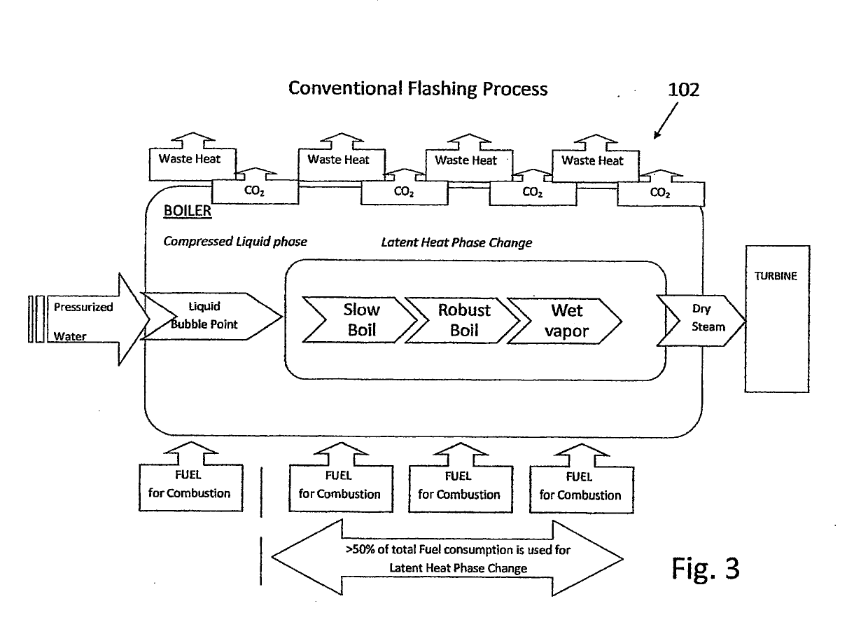

By adding a second vortex tube 530, and a second turbine 550, as shown in FIG. 3, there is a modest increase in power output. If a second feed pump 590 is added, only a minute increase in power is seen. Only after a second heat exchanger 580 is added, a significant increase in power is noted.

FIG. 9 is a schematic design depicting the Hardgrave process for vaporizing a pressurized subcooled liquid refrigerant stream 512 to produce electricity: use feed pump 500 to pump the subcooled liquid refrigerant stream 501 to a desired pressure; provide the pressurized subcooled liquid stream 502 into a heat exchanger 510; transfer heat from an external heat source into the pressurized subcooled liquid stream 502 to raise the stream temperature, but not vaporize the liquid stream 502, until stream 502 temperature is near the saturated liquid inlet temperature for the desired pressure; provide this hot pressurized subcooled liquid stream 512 into the inlet of a first conventional counter-flow vortex tube 520 to separate the hot compressed liquid stream 512 into two outflows: a first cool subcooled liquid stream 522; and the desired first supercritical refrigerant vapor stream 523, without the addition of “Latent Heat.” The first supercritical refrigerant vapor stream 523 is provided at a higher temperature than the saturated liquid inlet temperature for the desired pressure and the first supercritical refrigerant vapor stream 523 is used to drive a turbine 540 to produce electricity or convert the heat energy into a work, electrical or motive force. Feed the first cool subcooled liquid stream 522 into second feed pump 590 to pump the subcooled liquid refrigerant stream 522 to a desired pressure; provide the pressurized subcooled liquid stream 592 into a second heat exchanger 580; re-heat the subcooled liquid stream 592 to raise the stream temperature, but not vaporize the liquid stream 592, until stream 592 temperature is near the saturated liquid inlet temperature for the desired pressure; provide this hot pressurized subcooled liquid stream 582 into the inlet of a second conventional counter-flow vortex tube 530 to separate the hot subcooled liquid stream 582 into two outflows: a second cool subcooled liquid stream 532; and the desired second supercritical refrigerant vapor stream 533, without the addition of “Latent Heat.” The second supercritical refrigerant vapor stream 533 is provided at a higher temperature than the saturated liquid inlet temperature for the desired pressure, and the second supercritical refrigerant vapor stream 533 is used to drive a turbine 550 to produce electricity or convert the heat energy into a work, electrical or motive force.

The second cool subcooled liquid stream 532 is fed into a Joule-Thomson device 560 emerging with lower temperature and pressure as feed stream 562. The temperature and pressure of stream 523 is lowered when it emerges from the turbine 540 in feed stream 542. The temperature and pressure of stream 533 is lowered when it emerges from the turbine 550 in feed stream 552. Feed streams 552 and feed stream 562 are mixed forming feed stream 573, which is mixed with feed stream 542, the combined stream 572 is transmitted into the condenser 570. The condensed subcooled liquid refrigerant stream 501 is transmitted from the condenser 570 at a lower temperature, and is fed into inlet of pump 500, the place of beginning, completing the cycle.

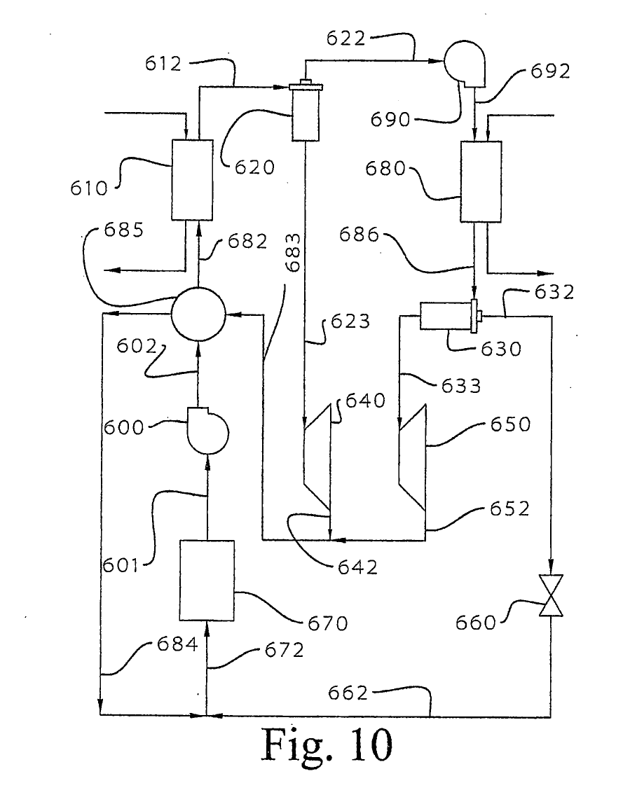

The invention shown as FIG. 10, is the same as the rudimentary Rankine Cycle with vortex tube 620, as shown by FIG. 5, with the addition of an economizing heat exchanger 685 and an alteration of the cool subcooled liquid return stream 622.

There are two positions for the addition of an economizing heat exchanger 685. The position chosen is between the feed pump 600 and the heat exchanger 610 to pre-heat the pressurized subcooled liquid stream 602 before being introduced into the heat exchanger 610. This position for the pre-heating process reduces the amount of heat transferred from an external heat source, thereby improving the heat efficiency.

The alternate position for the addition of an economizing heat exchanger 485 is between the second feed pump 690 and the second conventional counter-flow vortex tube 630 replacing the second heat exchanger 680 to pre-heat the first cool subcooled liquid stream 622 before being introduced into the second conventional counter-flow vortex tube 630. This position for the pre-heating process increases the power output of the second turbine 650 without additional heat from an external heat source.

The altered use of the cool subcooled liquid return stream 622 is to produce power by adding a second vortex tube 630 and a turbine 650, from the cool subcooled liquid return stream 622 residual energy, rather than just returning to its state of beginning for further cycling, as shown in this invention.

By adding a second vortex tube 630, and a second turbine 650, as shown in FIG. 3, there is a modest increase in power output. If a second feed pump 690 is added, only a minute increase in power is seen. Only after a second heat exchanger 680 is added, a significant increase in power is noted.

FIG. 10, is a schematic design depicting the Hardgrave process for vaporizing a pressurized subcooled liquid refrigerant stream 612 to produce electricity: use feed pump 600 to pump the subcooled liquid refrigerant stream 601 to a desired pressure; provide the pressurized subcooled liquid stream 602 into an economizing heat exchanger 685 to be pre-heated; and provide a pre-heated pressurized compressed liquid stream 682 into a heat exchanger 610. Transfer heat from an external heat source into the subcooled liquid stream 682 to raise the temperature, but not vaporize the liquid stream 682, until stream 682 temperature is near the saturated liquid inlet temperature for the desired pressure.

Provide this hot pressurized subcooled liquid stream 612 into the inlet of a first conventional counter-flow vortex tube 620 to separate the hot subcooled liquid stream 612 into two outflows: a first cool subcooled liquid stream 622; and the desired first supercritical refrigerant vapor stream 623, without the addition of “Latent Heat.” The first supercritical refrigerant vapor stream 623 is provided at a higher temperature than the saturated liquid inlet temperature for the desired pressure. Provide the first supercritical refrigerant vapor stream 623 to drive a turbine 640 to produce electricity or convert the heat energy into a work, electrical or motive force. Feed the first cool subcooled liquid stream 622 into a second feed pump 690 to pump the subcooled liquid refrigerant stream 622 to a desired pressure. Provide the pressurized subcooled liquid stream 692 into a second heat exchanger 680, re-heat the subcooled liquid stream 692 to raise the temperature, but not vaporize the liquid stream 692, until stream 692 temperature is near the saturated liquid inlet temperature for the desired pressure.

Provide this hot pressurized subcooled liquid stream 686 into the inlet of a second conventional counter-flow vortex tube 630 to separate the hot subcooled liquid stream 686 into two outflows: a second cool subcooled liquid stream 632; and the desired second supercritical refrigerant vapor stream 633, without the addition of “Latent Heat.” The second supercritical refrigerant vapor stream 633 is provided at a higher temperature than the saturated liquid inlet temperature for the desired pressure and the second supercritical refrigerant vapor stream 633 is used to drive a turbine 650 to produce electricity or convert the heat energy into a work, electrical or motive force.

The second cool subcooled liquid stream 632 is fed into a Joule-Thomson device 660 emerging with lower temperature and pressure as feed stream 662. The temperature and pressure of stream 623 is lowered when it emerges from the turbine 640 in feed stream 642. The temperature and pressure of stream 633 is lowered when it emerges from the turbine 650 in feed stream 652 which is mixed with feed stream 642.

The combined stream 683 is transmitted from the turbines 640 and 650 as a supercritical vapor into the economizing heat exchanger 685 to provide the heat for pre-heating the pressurized subcooled liquid stream 602. The temperature of feed stream 683 is lowered when it emerges from the economizing heat exchanger 685 as feed stream 684.

Feed stream 684 is combined with feed stream 662, the combined stream 672 is fed into a condenser 670. The condensed subcooled liquid refrigerant stream 601 is transmitted from the condenser 670 at a lower temperature, and is fed into pump 600, the place of beginning, completing the cycle.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

Having described the invention, we claim:

1. A process of making a superheated vapor from a compressed liquid comprising the steps:
entering at least one inlet tangentially a compressed liquid stream into the internal diameter and near perpendicular of a cylindrical inlet chamber, said compressed liquid stream transverses at least one inlet, reducing the liquid temperature and pressure,
creating a second duel-phase fluid stream having fluid expanding and straight line acceleration; said second duel-phase fluid stream following the inlet chamber internal diameter forcing a duel-phase fluid rotation developing a fluid vortex and vital angular momentum, also straight line forward and angular acceleration, initiating both a fluid temperature and pressure reduction, said second duel-phase fluid stream at least partially converting its pressure energy into the accelerating rotating fluid kinetic energy,
forming a condensate precipitating out of said accelerating rotating fluid,
emitting condensation heat,
forming and migrating condensate inward due to a loss of angular momentum and inward toward a lower pressure developing near the vortex center,
sweeping away residual liquid water and condensate by a passing swirling center counterflow vortex in close proximity, said inlet chamber having two outlets enables continuing fluid flow forward and exiting said inlet chamber and said vortex tube;
absorbs an abandoned condensation heat left behind with a wet accelerating rotating vapor, said wet accelerating rotating vapor becomes heated, creating a rotating heated vapor stream,
absorbing the condensation heat into said rotating heated vapor stream to accelerate angularly said rotating heated vapor stream, allowing a reduction in the spin diameter of said rotating heated vapor stream while maintaining near the same angular momentum, said rotating heated vapor stream being pushed forward by an entry pressure differential into the inlet chamber and afterwards into a smaller internal diameter tube, leaving the most liquid behind in the inlet chamber to convert into vapor;
said rotating heated vapor stream entering said smaller internal diameter tube, creating a hot rotating vapor stream increasing the kinetic energy,
said hot rotating vapor stream temperature and pressure both decrease, said decreasing pressure creates a pressure gradient that pushes stream flow forward to said hot rotating vapor stream;
said hot rotating vapor stream expands by reducing the vapor pressure and absorbing the abandoned condensation heat, said hot rotating vapor stream velocity accelerates angularly about a rotating axis and in a straight line forward, with condensate forms, precipitates-out, because of the loss of angular momentum while emitting condensation heat,
discharging condensate and sweeping away the condensate by said swirling center counterflow vortex passing in close proximity, said hot rotating vapor stream absorbing the condensation heat left behind,
creating a superheated vapor stream migrating outward, because of the gain of angular momentum by absorbing condensation heat, the difference in angular momentum separates the two energies, a hot superheated vapor stream continuing to expand until reaching the end of the tube, precipitating condensate and absorbing condensation heat, said hot superheated vapor stream becoming hotter migrating outward gathering on the outer edge of said hot rotating vapor stream next to a tube internal diameter wall, allowing only this hot superheated vapor outer edge to pass the tube end,
valving control regulating mass flow to balance the volume flow rates of liquid and vapor components, with the remaining hot rotating vapor stream being deflected back, reversing the remaining flow stream and forming said swirling center counterflow vortex continuing backward exiting the inlet chamber outlet and exiting said vortex tube.

2. The process of claim 1 wherein said compressed liquid stream is a heated non-boiling compressed liquid stream.

3. The process of claim 1 wherein at least one inlet is at least one nozzle.

4. The process of claim 1 wherein said vortex tube is a vortex steam generator.

5. A process comprising the steps of:
providing an inlet chamber internal diameter that is equal to said tube internal diameter, both being said tube without said inlet chamber impediment;
absorbing the abandoned condensation by said rotating heated vapor stream as heat accelerates angularly,
creating a hot rotating vapor stream increasing the kinetic energy,
diminishing the pressure gradient to push said hot rotating vapor stream axially forward,
decreasing said hot rotating vapor stream temperature and pressure,
expanding said hot rotating vapor stream by reducing vapor pressure and absorbing said abandoned condensation heat;
accelerating the angular velocity of said hot rotating vapor stream about a rotating axis and in a straight line forward,
continuing to form condensate, precipitating-out, and emitting condensation heat,
discharging condensate and sweeping away the condensate by said swirling center counterflow vortex passing in close proximity,
absorbing said hot rotating vapor stream with the condensation heat left behind,
creating a superheated vapor stream migrating outward,
continuing to expand a hot superheated vapor stream until reaching the end of the tube, precipitating condensate and absorbing condensation heat, and,
heating said hot superheated vapor stream and migrating outward gathering on the outer edge of said hot rotating vapor stream, covering the tube internal diameter wall, allowing only said hot superheated vapor covering to pass the tube end. cm 6. A system that provides a superheated vapor from a compressed liquid comprising:
an inlet chamber having at least one entry inlet receiving a first compressed liquid stream tangentially and near perpendicular to the cylindrical internal diameter of said inlet chamber;
said inlet chamber having at least one inlet producing a second straight line compressed liquid stream passing through at least one inlet reducing said second straight line compressed liquid stream temperature and pressure, changing state creating a third duel-phase fluid stream exhibiting fluid expansion and acceleration;
said inlet chamber internal diameter forcing said third duel-phase fluid stream to rotate developing a fourth rotating duel-phase vortex stream,
said inlet chamber forced rotation changing both fluid temperature and pressure of said third duel-phase fluid stream developing said fourth rotating duel-phase vortex stream decreasing temperature and pressure, exhibiting expansion and angular acceleration, causing condensate separation by loss of condensate angular momentum, while maintaining the balance with the angular momentum gain of the rotating vapor, precipitating out of said fourth rotating duel-phase vortex stream, emitting condensation heat;
said inlet chamber condensate forms and migrates inward due to a loss of angular momentum caused by loss of heat and inward toward a lower pressure developing near the vortex center,
said inlet chamber having two outlets of particular size, first outlet for continuing forward in said vortex tube and the second outlet for exiting said vortex tube, said inlet chamber residual liquid water and condensate are swept away by a swirling center counterflow vortex exiting the second outlet and exiting said vortex tube;
said fifth rotating vapor absorbs an abandoned condensation heat left behind, said fifth rotating vapor becomes heated, creating a sixth rotating heated vapor stream, said sixth rotating heated vapor stream migrating outward due to a gain of angular momentum caused by a gain of heat, while maintaining a balance in angular momentum with said condensate;
said inlet chamber transitioning from said cylindrical internal diameter to said first outlet presents an impediment for moving forward the angular stream flow, said inlet chamber said sixth rotating heated vapor stream increasing angular acceleration allowing a reduction in the spin diameter of said sixth rotating heated vapor stream in order to exit said inlet chamber through particular reduced internal diameter of said first outlet,
said inlet chamber said sixth rotating heated vapor stream changing state, creating a seventh hot rotating vapor stream exhibiting vapor expansion and angular acceleration being pushed forward by said entry pressure differential from said inlet chamber into said first outlet of smaller internal diameter, leaving the most liquid behind in said inlet chamber farther converting into vapor or for disposal,
said first outlet releasing said seventh hot rotating vapor stream exhibiting vapor expansion and angular acceleration pushing forward into a tube; said tube receiving said seventh hot rotating vapor stream pushing forward decreasing temperature and pressure, forming a condensate precipitating out of said seventh hot rotating vapor stream, emitting condensation heat;
said tube condensate precipitating and migrating inward due to a loss of angular momentum caused by loss of heat and inward toward a lower pressure developing near the tube vortex center, said tube said seventh hot rotating vapor stream migrating outward due to a gain of angular momentum caused by a gain of heat, while maintaining a balance in angular momentum with said tube condensate; said tube condensate is swept away by said swirling center counterflow vortex exiting the second outlet and exiting said vortex tube;
said seventh hot rotating vapor stream absorbing the condensation heat left behind, said seventh hot rotating vapor stream becoming heated, creating an eighth dryer and superheated vapor stream, said eighth dryer and superheated vapor stream continuing to expand pushing forward until reaching the end of said tube, precipitating condensate and absorbing condensation heat, said eighth dryer and superheated vapor stream becoming hotter gathering on the outer edge of said seventh hot rotating vapor stream,
said tube end allowing only said eighth dryer and superheated vapor stream gathering on the outer edge to pass the tube end continuing forward for farther use; said tube end causing said seventh hot rotating vapor stream to be deflected back reversing the flow stream forming said swirling center counterflow vortex,
said tube swirling counterflow vortex continuing backward collecting precipitating condensate and releasing at least additional condensation heat for absorbing, said tube swirling counterflow vortex continuing backward exiting the second outlet and exiting said vortex tube.

7. The apparatus according to claim 6 wherein at least one inlet is at least one nozzle.

8. The apparatus according to claim 6 wherein first compressed liquid stream is a first heated non-boiling compressed liquid stream.

9. The apparatus according to claim 6 wherein a vortex tube is a vortex steam generator.

10. The apparatus according to claim 6 wherein said first outlet internal diameter is equal to the cylindrical internal diameter of said inlet chamber; said tube internal diameter is smaller than or near equal to the internal diameter of the cylindrical internal diameter of said inlet chamber.

11. A process for providing a superheated vapor from a liquid stream comprising the steps of:
providing a first liquid stream;
increasing the pressure of a first liquid stream;
providing a first compressed liquid stream;
heating said first compressed liquid stream in a first heat exchanger, said first heat exchanger producing a second non-boiling compressed liquid stream that has a higher temperature than said first compressed liquid stream, said first heat exchanger receiving heat from a first external heat source;
providing said second non-boiling compressed liquid stream to a vortex tube to separate said second compressed non-boiling liquid stream into a second cool fluid stream and a hot second superheated vapor stream, without additional heat from an external heat source;
providing said hot second superheated vapor stream from said vortex tube for use.

12. The process of claim 11 further comprising the steps of:
heating said first compressed liquid stream to a non-boiling temperature, without boiling said second non-boiling compressed liquid stream, until said second non-boiling compressed liquid stream temperature is near liquid saturation temperature and below for that compressing pressure.

13. The process of claim 11 wherein liquid stream is a liquid water stream.

14. The process of claim 11 wherein vapor stream is a steam stream.

15. The process of claim 11 wherein a first heat exchanger is a shell and plate heat exchanger.

16. The process of claim 11 wherein a first heat exchanger is absent and said first compressed liquid stream is provided as a second non-boiling compressed liquid stream from an external heat source, and provided directly to said vortex tube.

17. The process of claim 11 wherein said first heat exchanger produces a second non-boiling compressed liquid stream that has a higher temperature than said first compressed liquid stream, said first heat exchanger receiving heat from a first external heat source; and
said first vortex tube receiving said second non-boiling compressed liquid stream being segregated in said first vortex tube into a hot second superheated vapor stream and a second sub-cooled liquid stream,
a first turbine receives said hot second superheated vapor stream for use.

18. The process of claim 11 wherein liquid stream is a liquid water stream.

19. The process of claim 11 wherein vapor stream is a steam stream.

20. The process of claim 11 wherein a first heat exchanger is a shell and plate heat exchanger.

21. The process of claim 11 wherein a first heat exchanger is absent and said first compressed liquid stream is provided as a second non-boiling compressed liquid stream from an external heat source, and provided to said vortex tube.

22. The process of claim 11 wherein said first heat exchanger heating said first compressed liquid stream to a non-boiling temperature; said first heat exchanger heating said second non-boiling compressed liquid stream until said second non-boiling compressed liquid stream temperature is near liquid saturation temperature and below for that particular compressing pressure.
